(19) United States
(12) Patent Application Publication
(10) Pub. No.: US 2023/0186119 A1
(43) Pub. Date: Jun. 15, 2023

(54) GENERATING PARAMETER VALUES FOR PERFORMANCE TESTING UTILIZING A REINFORCEMENT LEARNING FRAMEWORK

(71) Applicant: Dell Products L.P., Round Rock, TX (US)

(72) Inventors: Chi Chen, Chengdu (CN); Changyue Dai, Chengdu (CN); Hailan Dong, Chengdu (CN)

(21) Appl. No.: 17/560,459

(22) Filed: Dec. 23, 2021

(30) Foreign Application Priority Data
Dec. 15, 2021 (CN) 202111545266.0

(51) Int. Cl. G06N 5/02

(52) U.S. Cl. CPC G06N 5/027

(57) ABSTRACT

An apparatus comprises a processing device configured to detect a request for parameter values to be utilized in a given iteration of performance testing of an information technology (IT) asset in an IT infrastructure, to determine a current state of the IT asset, the current state comprising two or more performance metric values, and to generate, utilizing a reinforcement learning framework, the parameter values to be utilized in the given iteration of the performance testing of the IT asset based at least in part on the current state. The processing device is also configured to perform the given iteration of performance testing of the IT asset utilizing the generated parameter values, and to update the reinforcement learning framework based at least in part on a subsequent state of the IT asset following the given iteration of performance testing of the IT asset.

### RELATED APPLICATION

The present application claims priority to Chinese Patent Application No. 202111545266.0, filed on Dec. 15, 2021 and entitled “Generating Parameter Values for Performance Testing Utilizing a Reinforcement Learning Framework,” which is incorporated by reference herein in its entirety.

### FIELD

The field relates generally to information processing, and more particularly to storage in information processing systems.

### BACKGROUND

Storage arrays and other types of storage systems are often shared by multiple host devices over a network. Applications running on the host devices each include one or more processes that perform the application functionality. Such processes issue input-output (IO) operation requests for delivery to the storage systems. Storage controllers of the storage systems service such requests for IO operations. In some information processing systems, multiple storage systems may be used to form a storage cluster.

### SUMMARY

Illustrative embodiments of the present disclosure provide techniques for generating parameter values for performance testing utilizing a reinforcement learning framework.

In one embodiment, an apparatus comprises at least one processing device comprising a processor coupled to a memory. The at least one processing device is configured to perform the steps of detecting a request for parameter values for a set of parameters to be utilized in a given iteration of performance testing of an information technology asset in an information technology infrastructure, determining a current state of the information technology asset, the current state of the information technology asset comprising two or more performance metric values for the information technology asset, and generating, utilizing a reinforcement learning framework, the parameter values for the set of parameters to be utilized in the given iteration of the performance testing of the information technology asset based at least in part on the current state of the information technology asset. The at least one processing device is also configured to perform the steps of performing the given iteration of performance testing of the information technology asset utilizing the generated parameter values for the set of parameters, and updating the reinforcement learning framework based at least in part on a subsequent current state of the information technology asset following the given iteration of performance testing of the information technology asset.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for generating parameter values for performance testing utilizing a reinforcement learning framework in an illustrative embodiment.

FIG. 2 is a flow diagram of an exemplary process for generating parameter values for performance testing utilizing a reinforcement learning framework in an illustrative embodiment.

FIG. 3 shows examples of input-output patterns for different applications in an illustrative embodiment.

FIG. 4 shows a reinforcement learning framework for generating input-output patterns for storage system performance testing in an illustrative embodiment.

FIG. 5 shows performance tuning policies for a set of input-output parameters in an illustrative embodiment.

FIG. 6 shows an action space for the set of performance tuning policies of FIG. 5 in an illustrative embodiment.

FIG. 7 shows a system for an automation test client to obtain recommended input-output patterns for storage system performance testing in an illustrative embodiment.

FIG. 8 shows a process flow for a storage system performance testing agent to generate input-output pattern recommendations for storage system performance testing in an illustrative embodiment.

FIG. 9 shows action-value mapping for long-term values of actions in an illustrative embodiment.

FIGS. 10 and 11 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

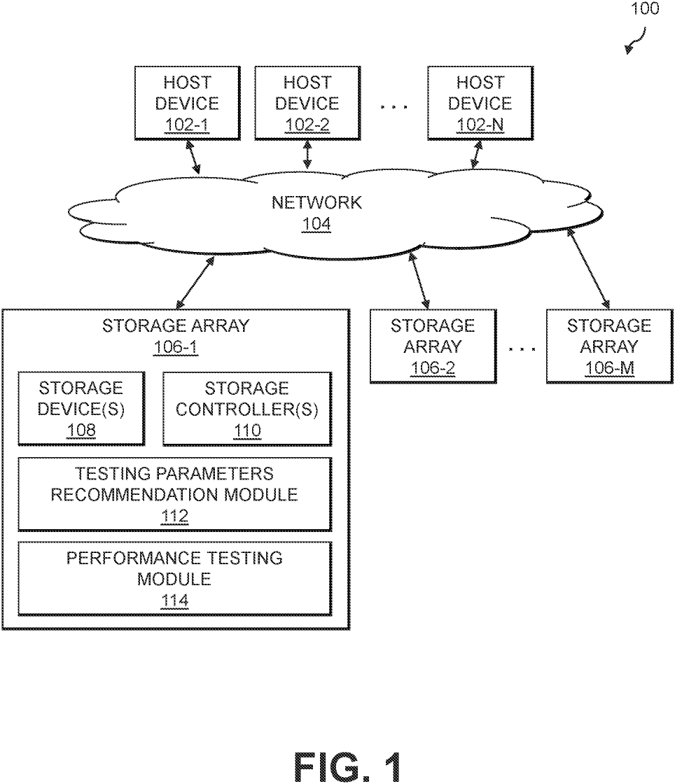

FIG. 1 shows an information processing system 100 configured in accordance with an illustrative embodiment to provide functionality for generating parameter values for performance testing utilizing a reinforcement learning framework. The information processing system 100 comprises one or more host devices 102-1, 102-2, ... 102-N (collectively, host devices 102) that communicate over a network 104 with one or more storage arrays 106-1, 106-2, ... 106-M (collectively, storage arrays 106). The network 104 may comprise a storage area network (SAN).

The storage array 106-1, as shown in FIG. 1, comprises a plurality of storage devices 108 each storing data utilized by one or more applications running on the host devices 102. The storage devices 108 are illustratively arranged in one or more storage pools. The storage array 106-1 also comprises one or more storage controllers 110 that facilitate IO processing for the storage devices 108. The storage array 106-1 and its associated storage devices 108 are an example of what is more generally referred to herein as a “storage system.” This storage system in the present embodiment is shared by the host devices 102, and is therefore also referred to herein as a “shared storage system.” In embodiments where there is only a single host device 102, the host device 102 may be configured to have exclusive use of the storage system. In some embodiments, the storage arrays 106 may be part of a storage cluster (e.g., where the storage arrays 106 may be used to implement one or more storage nodes in a cluster storage system comprising a plurality of storage nodes interconnected by one or more networks), and the host devices 102 are assumed to submit IO operations to be processed by the storage cluster.

The host devices 102 illustratively comprise respective computers, servers or other types of processing devices capable of communicating with the storage arrays 106 via the network 104. For example, at least a subset of the host devices 102 may be implemented as respective virtual machines of a compute services platform or other type of processing platform. The host devices 102 in such an arrangement illustratively provide compute services such as execution of one or more applications on behalf of each of one or more users associated with respective ones of the host devices 102.

The term “user” herein is intended to be broadly construed so as to encompass numerous arrangements of human, hardware, software or firmware entities, as well as combinations of such entities.

Compute and/or storage services may be provided for users under a Platform-as-a-Service (PaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

The storage devices 108 of the storage array 106-1 may implement logical units (LUNs) configured to store objects for users associated with the host devices 102. These objects can comprise files, blocks or other types of objects. The host devices 102 interact with the storage array 106-1 utilizing read and write commands as well as other types of commands that are transmitted over the network 104. Such commands in some embodiments more particularly comprise Small Computer System Interface (SCSI) commands, although other types of commands can be used in other embodiments. A given IO operation as that term is broadly used herein illustratively comprises one or more such commands. References herein to terms such as “input-output” and “IO” should be understood to refer to input and/or output. Thus, an IO operation relates to at least one of input and output.

Also, the term “storage device” as used herein is intended to be broadly construed, so as to encompass, for example, a logical storage device such as a LUN or other logical storage volume. A logical storage device can be defined in the storage array 106-1 to include different portions of one or more physical storage devices. Storage devices 108 may therefore be viewed as comprising respective LUNs or other logical storage volumes.

The storage devices 108 of the storage array 106-1 can be implemented using solid state drives (SSDs). Such SSDs are implemented using non-volatile memory (NVM) devices such as flash memory. Other types of NVM devices that can be used to implement at least a portion of the storage devices 108 include non-volatile random access memory (NVRAM), phase-change RAM (PC-RAM) and magnetic RAM (MRAM). These and various combinations of multiple different types of NVM devices or other storage devices may also be used. For example, hard disk drives (HDDs) can be used in combination with or in place of SSDs or other types of NVM devices. Accordingly, numerous other types of electronic or magnetic media can be used in implementing at least a subset of the storage devices 108.

At least one of the storage controllers of the storage arrays 106 (e.g., the storage controller 110 of storage array 106-1) is assumed to implement functionality for autonomous learning-based storage performance testing (e.g., of the storage arrays 106). Such autonomous learning-based storage performance testing functionality is provided via a testing parameters recommendation module 112 and a performance testing module 114. The testing parameters recommendation module 112 is configured to detect a request for parameter values for a set of parameters (e.g., IO patterns) that are to be utilized in a given iteration of performance testing of an information technology (IT) asset (e.g., the storage array 106-1, one or more other ones of the storage arrays 106, a storage cluster comprising two or more of the storage arrays 106, one or more of the host devices 102, etc.) in an IT infrastructure. The testing parameters recommendation module 112 is also configured to determine a current state of the IT asset, where the current state may comprise performance metric values for the IT asset.

The testing parameters recommendation module 112 is further configured to generate, utilizing a reinforcement learning framework, the parameter values for the set of parameters to be utilized in the given iteration of the performance testing of the IT asset based at least in part on the current state of the IT asset. Generating the parameter values for the set of parameters to be utilized in the given iteration of the performance testing of the IT asset may be further based at least in part on learned experience of the reinforcement learning framework. The learned experience may comprise characterizations of whether different sets of one or more actions that modify the parameter values for the set of parameters, taken from the current state of the IT asset, meet one or more designated testing goals for the performance testing of the IT asset.

The performance testing module 114 is configured to perform the given iteration of performance testing of the IT asset utilizing the generated parameter values for the set of parameters. The performance testing module 114 is also configured to update the reinforcement learning framework based at least in part on a subsequent state of the IT asset following the given iteration of performance testing of the IT asset.

In some embodiments, the storage arrays 106 in the FIG. 1 embodiment provide or implement multiple distinct storage tiers of a multi-tier storage system. By way of example, a given multi-tier storage system may comprise a fast tier or performance tier implemented using flash storage devices or other types of SSDs, and a capacity tier implemented using HDDs, possibly with one or more such tiers being server based. A wide variety of other types of storage devices and multi-tier storage systems can be used in other embodiments, as will be apparent to those skilled in the art. The particular storage devices used in a given storage tier may be varied depending on the particular needs of a given embodiment, and multiple distinct storage device types may be used within a single storage tier. As indicated previously, the term “storage device” as used herein is intended to be broadly construed, and so may encompass, for example, SSDs, HDDs, flash drives, hybrid drives or other types of storage products and devices, or portions thereof, and illustratively include logical storage devices such as LUNs.

It should be appreciated that a multi-tier storage system may include more than two storage tiers, such as one or more “performance” tiers and one or more “capacity” tiers, where the performance tiers illustratively provide increased IO performance characteristics relative to the capacity tiers and the capacity tiers are illustratively implemented using relatively lower cost storage than the performance tiers. There may also be multiple performance tiers, each providing a different level of service or performance as desired, or multiple capacity tiers.

Although in the FIG. 1 embodiment the testing parameters recommendation module 112 and the performance testing module 114 are shown as being implemented internal to the storage array 106-1 and outside the storage controllers 110, in other embodiments one or both of the testing parameters recommendation module 112 and the performance testing module 114 may be implemented at least partially internal to the storage controllers 110 or at least partially outside the storage array 106-1, such as on one of the host devices 102, one or more other ones of the storage arrays 106-2 through 106-M, on one or more servers external to the host devices 102 and the storage arrays 106 (e.g., including on a cloud computing platform or other type of information technology (IT) infrastructure), etc. Further, although not shown in FIG. 1, other ones of the storage arrays 106-2 through 106-M may implement respective instances of the testing parameters recommendation module 112 and the performance testing module 114.

At least portions of the functionality of the testing parameters recommendation module 112 and the performance testing module 114 may be implemented at least in part in the form of software that is stored in memory and executed by a processor.

The host devices 102 and storage arrays 106 in the FIG. 1 embodiment are assumed to be implemented using at least one processing platform, with each processing platform comprising one or more processing devices each having a processor coupled to a memory. Such processing devices can illustratively include particular arrangements of compute, storage and network resources. For example, processing devices in some embodiments are implemented at least in part utilizing virtual resources such as virtual machines (VMs) or Linux containers (LXCs), or combinations of both as in an arrangement in which Docker containers or other types of LXCs are configured to run on VMs.

The host devices 102 and the storage arrays 106 may be implemented on respective distinct processing platforms, although numerous other arrangements are possible. For example, in some embodiments at least portions of one or more of the host devices 102 and one or more of the storage arrays 106 are implemented on the same processing platform. One or more of the storage arrays 106 can therefore be implemented at least in part within at least one processing platform that implements at least a subset of the host devices 102.

The network 104 may be implemented using multiple networks of different types to interconnect storage system components. For example, the network 104 may comprise a SAN that is a portion of a global computer network such as the Internet, although other types of networks can be part of the SAN, including a wide area network (WAN), a local area network (LAN), a satellite network, a telephone or cable network, a cellular network, a wireless network such as a WiFi or WiMAX network, or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

Although in some embodiments certain commands used by the host devices 102 to communicate with the storage arrays 106 illustratively comprise SCSI commands, other types of commands and command formats can be used in other embodiments. For example, some embodiments can implement IO operations utilizing command features and functionality associated with NVM Express (NVMe), as described in the NVMe Specification, Revision 1.3, May 2017, which is incorporated by reference herein. Other storage protocols of this type that may be utilized in illustrative embodiments disclosed herein include NVMe over Fabric, also referred to as NVMeoF, and NVMe over Transmission Control Protocol (TCP), also referred to as NVMe/TCP.

The storage array 106-1 in the present embodiment is assumed to comprise a persistent memory that is implemented using a flash memory or other type of non-volatile memory of the storage array 106-1. More particular examples include NAND-based flash memory or other types of non-volatile memory such as resistive RAM, phase change memory, spin torque transfer magneto-resistive RAM (STT-MRAM) and Intel Optane™ devices based on 3D XPoint™ memory. The persistent memory is further assumed to be separate from the storage devices 108 of the storage array 106-1, although in other embodiments the persistent memory may be implemented as a designated portion or portions of one or more of the storage devices 108. For example, in some embodiments the storage devices 108 may comprise flash-based storage devices, as in embodiments involving all-flash storage arrays, or may be implemented in whole or in part using other types of non-volatile memory.

As mentioned above, communications between the host devices 102 and the storage arrays 106 may utilize PCIe connections or other types of connections implemented over one or more networks. For example, illustrative embodiments can use interfaces such as Internet SCSI (iSCSI), Serial Attached SCSI (SAS) and Serial ATA (SATA). Numerous other interfaces and associated communication protocols can be used in other embodiments.

The storage arrays 106 in some embodiments may be implemented as part of a cloud-based system.

It should therefore be apparent that the term “storage array” as used herein is intended to be broadly construed, and may encompass multiple distinct instances of a commercially-available storage array.

Other types of storage products that can be used in implementing a given storage system in illustrative embodiments include software-defined storage, cloud storage, object-based storage and scale-out storage. Combinations of multiple ones of these and other storage types can also be used in implementing a given storage system in an illustrative embodiment.

In some embodiments, a storage system comprises first and second storage arrays arranged in an active-active configuration. For example, such an arrangement can be used to ensure that data stored in one of the storage arrays is replicated to the other one of the storage arrays utilizing a synchronous replication process. Such data replication across the multiple storage arrays can be used to facilitate failure recovery in the system 100. One of the storage arrays may therefore operate as a production storage array relative to the other storage array which operates as a backup or recovery storage array.

It is to be appreciated, however, that embodiments disclosed herein are not limited to active-active configurations or any other particular storage system arrangements. Accordingly, illustrative embodiments herein can be configured using a wide variety of other arrangements, including, by way of example, active-passive arrangements, active-active Asymmetric Logical Unit Access (ALUA) arrangements, and other types of ALUA arrangements.

These and other storage systems can be part of what is more generally referred to herein as a processing platform comprising one or more processing devices each comprising a processor coupled to a memory. A given such processing device may correspond to one or more virtual machines or other types of virtualization infrastructure such as Docker containers or other types of LXCs. As indicated above, communications between such elements of system 100 may take place over one or more networks.

The term “processing platform” as used herein is intended to be broadly construed so as to encompass, by way of illustration and without limitation, multiple sets of processing devices and one or more associated storage systems that are configured to communicate over one or more networks. For example, distributed implementations of the host devices 102 are possible, in which certain ones of the host devices 102 reside in one data center in a first geographic location while other ones of the host devices 102 reside in one or more other data centers in one or more other geographic locations that are potentially remote from the first geographic location. The storage arrays 106 may be implemented at least in part in the first geographic location, the second geographic location, and one or more other geographic locations. Thus, it is possible in some implementations of the system 100 for different ones of the host devices 102 and the storage arrays 106 to reside in different data centers.

Numerous other distributed implementations of the host devices 102 and the storage arrays 106 are possible. Accordingly, the host devices 102 and the storage arrays 106 can also be implemented in a distributed manner across multiple data centers.

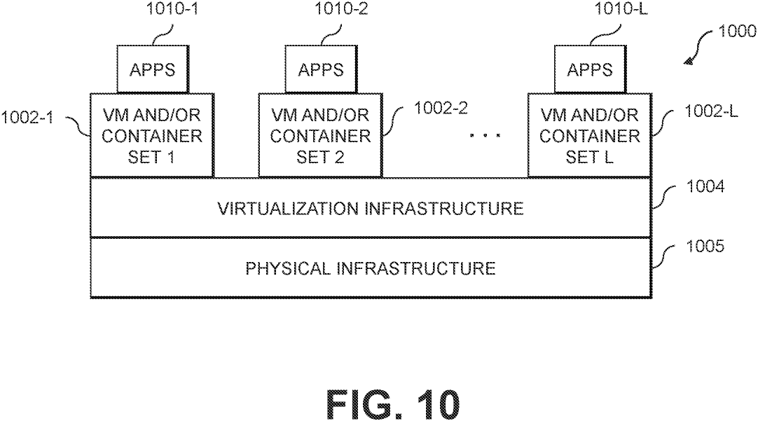

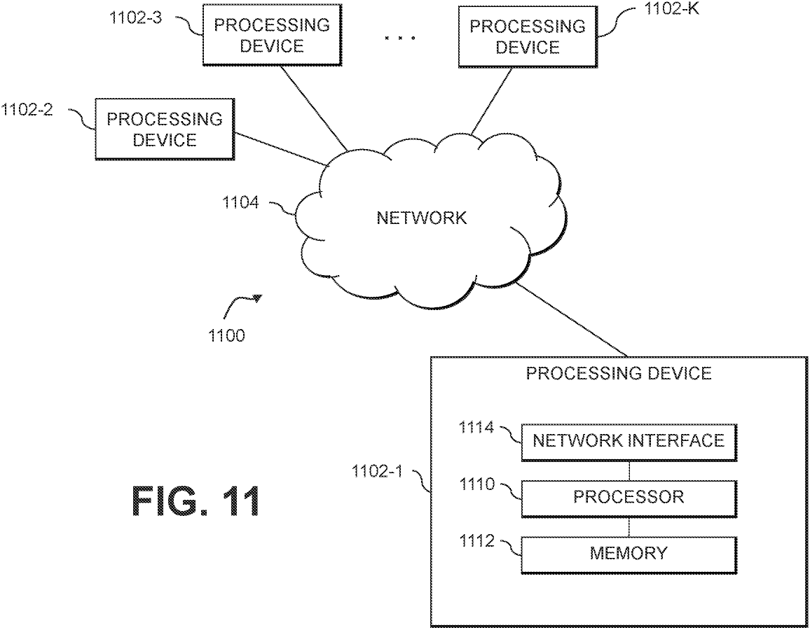

Additional examples of processing platforms utilized to implement portions of the system 100 in illustrative embodiments will be described in more detail below in conjunction with FIGS. 10 and 11.

It is to be understood that the particular set of elements shown in FIG. 1 for generating parameter values for performance testing utilizing a reinforcement learning framework is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

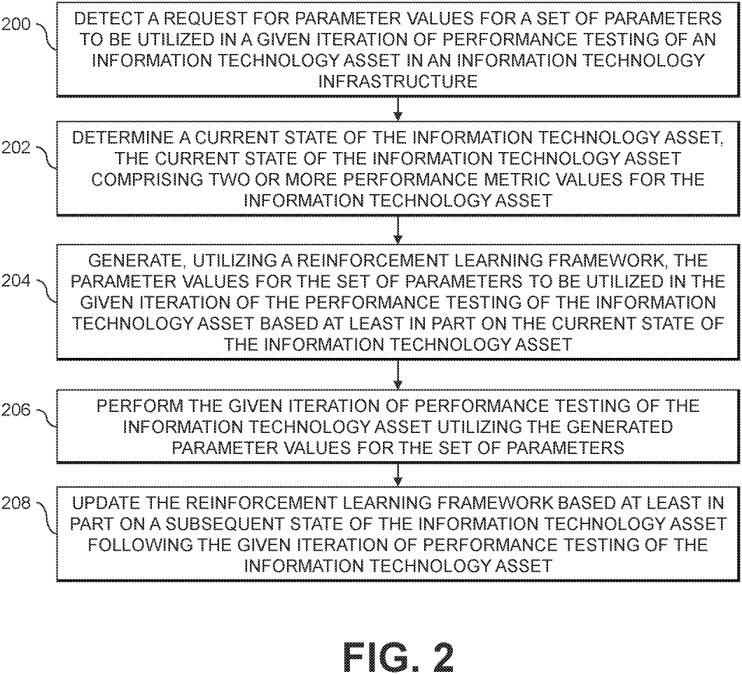

An exemplary process for generating parameter values for performance testing utilizing a reinforcement learning framework will now be described in more detail with reference to the flow diagram of FIG. 2. It is to be understood that this particular process is only an example, and that additional or alternative processes for generating parameter values for performance testing utilizing a reinforcement learning framework may be used in other embodiments.

In this embodiment, the process includes steps 200 through 208. These steps are assumed to be performed by the testing parameters recommendation module 112 and the performance testing module 114. The process begins with step 200, detecting a request for parameter values for a set of parameters to be utilized in a given iteration of performance testing of an IT asset (e.g., the storage array 106-1) in an IT infrastructure (e.g., the system 100). In step 202, a current state of the information technology asset is determined. The current state of the IT asset comprises two or more performance metric values for the IT asset. The current state of the IT asset may further comprise testing information associated with the performance testing of the IT asset and configuration information for the IT asset. The configuration information for the IT asset may comprise at least one of a hardware configuration of the IT asset and a software configuration of the IT asset.

In step 204, the parameter values for the set of parameter values to be utilized in the given iteration of the performance testing of the IT asset are generated, utilizing a reinforcement learning framework, based at least in part on the current state of the IT asset. Step 204 may be further based at least in part on learned experience of the reinforcement learning framework. The learned experience comprises characterizations of whether different sets of one or more actions that modify the parameter values for the set of parameters, taken from the current state of the IT asset, meet one or more designated testing goals for the performance testing of the IT asset. The reinforcement learning framework may utilize a reward function which assigns a reward to the parameter values generated for the set of parameters that are utilized in the given iteration of performing testing of the IT asset based at least in part on whether the subsequent state of the IT asset following the given iteration of performance testing of the IT asset advances the one or more designated testing goals. The one or more designated testing goals may comprise target utilization values for the two or more performance metrics of the IT asset. The request may be detected in step 200 responsive to determining that a previous iteration of the performance testing of the IT asset did not meet the one or more designated testing goals.

In some embodiments, step 202 comprises determining whether the current state of the IT asset matches any of a plurality of state-action records of learned experience maintained by the reinforcement learning framework. Each of the plurality of state-action records specifies a given value characterizing an extent to which taking a given set of one or more actions for modifying the parameter values for the set of parameter values from a given state of the IT asset meets one or more designated testing goals for the performance testing of the IT asset. Responsive to determining that the current state of the IT asset does not match any of the plurality of state-action records, a set of one or more actions for modifying the parameter values for the set of parameters is selected randomly from an action space, where the action space defining permissible modifications to respective ones of the parameters in the set of parameters.

Responsive to determining that the current state of the IT asset matches a given one of the plurality of state-action records, a first set of one or more actions specified in the given one of the plurality of state-action records matching the current state of the information technology asset is selected with a first probability, and a second set of one or more actions for modifying the parameter values for the set of parameters is selected with a second probability randomly from an action space, where the action space defining permissible modifications to respective ones of the parameters in the set of parameters. The second probability is set to zero responsive to determining that the given value specified in the given one of the plurality of state-action records matching the current state of the IT asset indicates that the given set of one or more actions for modifying the parameter values for the set of parameters will meet the one or more designated testing goals within a threshold number of iterations of performance testing of the IT asset. The second probability is set to a non-zero value responsive to determining that the given value specified in the given one of the plurality of state-action records matching the current state of the IT asset indicates that the given set of one or more actions for modifying the parameter values for the set of parameters will not meet the one or more designated testing goals within a threshold number of iterations of performance testing of the IT asset.

The FIG. 2 process continues with step 206, performing the given iteration of performance testing of the IT asset utilizing the generated parameter values for the set of parameters. The reinforcement learning framework is updated in step 208 based at least in part on the subsequent state of the IT asset following the given iteration of performance testing of the IT asset. In some embodiments, the IT asset comprises a storage system (e.g., the storage array 106-1), and the set of parameters comprise two or more IO parameters to be utilized in modeling application workloads executing on the storage system. The two or more IO parameters may comprise at least two of IO size, a read/write ratio, a random/sequential ratio, and an IO thread number.

Illustrative embodiments provide techniques enabling an end-to-end autonomous performance testing solution utilizing reinforcement learning. Reinforcement learning simulates the human brain to learn in a trial-and-error manner. In some embodiments, reinforcement learning is used to find particular IO patterns and combinations of IO patterns which have the biggest impact on storage system performance (e.g., as measured based on various factors such as CPU or compute resource utilization, memory utilization, IO latency, etc.). This information is then used to perform testing of storage systems (e.g., to stress a storage system). Insights gained from testing experience are used to continue the reinforcement learning process. In this way, storage performance testing efficiency is improved, as fewer trials may be required to find storage system performance issues, or to otherwise meet performance testing goals without being heavily dependent on manual testers’ experience.

It should be noted that while various embodiments are described herein with respect to testing of storage system performance, the techniques described herein may similarly be used for other types of testing. For example, the end-to-end autonomous performance testing solution utilizing reinforcement learning may be used to perform testing of other types of assets in an information technology (IT) infrastructure. Such assets may include physical and virtual computing resources. The particular parameters used in testing may vary based on the type of asset being tested.

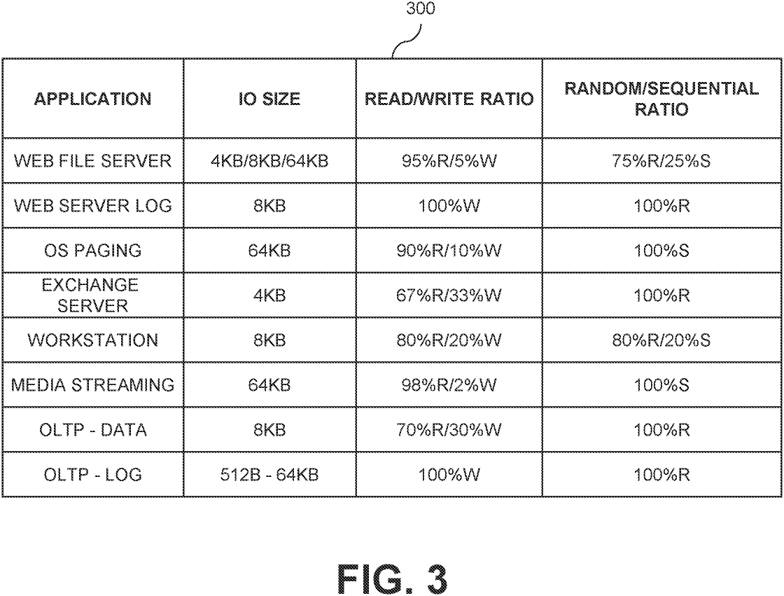

Different applications may run storage workloads having varying IO characteristics. Thus, to analyze and tune performance of a storage system, it is important to understand the types of storage workloads that applications or hosts utilizing the storage system are generating. Storage workloads may be described in terms of various characteristics, including but not limited to IO size, read/write ratio, random/sequential ratio, etc. FIG. 3 shows a table 300 illustrating various examples of applications and their associated storage workload characteristics (e.g., IO size, read/write ratio and random/sequential ratio). Such applications include: a web file server, a web server logging, operating system (OS) paging, exchange server, workstation, media streaming, online transaction processing (OLTP) data, and OLTP logging. The web file server application, for example, may have an IO size of 4 kilobytes (KB), 8 KB or 64 KB, with a read/write ratio of 95% read and 5% write, and a random/sequential ratio of 75% random and 25% sequential. As another example, the OLTP logging application may have an IO size of 512 bytes (B) to 64 KB, a read/write ratio of 100% write, and a random/sequential ratio of 100% random. It should be noted that the particular applications and their associated storage workload characteristics shown in the table 300 of FIG. 3 are presented by way of example only, and that in other embodiments there may be various other types of applications that utilize storage systems, or the applications listed in the table 300 of FIG. 3 may have different values for their associated storage workload characteristics.

During storage system testing, various types of IO tools may be used to simulate the storage workload characteristics of different applications. This may include simulating application IO patterns and specific combinations of IO patterns utilized by different applications.

In a storage system, an IO path may include one or more caches, internal buffers, pools, redundant arrays of independent disks (RAIDs), and backend storage drive IO. Different IO patterns, and different combinations of IO patterns, will have different impacts on overall storage system performance. Random and small IO requests may lead to storage system performance degradation. IO request size may influence storage system performance throughput (e.g., generally, the larger the IO size the higher the storage bandwidth). Writes are more expensive than reads, as the storage system needs to determine where to put new chunks of data and, once such a decision is made as to where to place the data, the write itself is time consuming due to RAID write penalties. Different combinations of IO patterns can also influence storage system performance throughput, and may be dependent on the storage system’s hardware and software configuration.

Conventional IO storage system testing tools utilize IO patterns in one of two ways: random and round robin. As such, conventional IO storage system testing tools do not know the exact storage system performance impact of IO patterns and combinations of IO patterns. Conventional IO storage system testing tools thus do not use the most effective IO patterns and combinations of IO patterns that will stress the storage system being tested. This leads to low overall IO testing efficiency.

Finding IO patterns and combinations of IO patterns that impact storage system performance may rely on time consuming and error prone manual tester effort. Testers may manually generate different combinations of IO patterns, based on deep dives of source code, modeling of real end-user workloads, analysis of storage system models, and previous experience. Testers may execute performance test cases by applying various workloads on storage systems and then measuring various performance metrics (e.g., latency, CPU or other compute resource utilization, memory utilization, bandwidth utilization, etc.) during the test execution. If one or more test goals are not achieved, the tester may modify the IO patterns and combinations of IO patterns which are used, and execute testing again and again. During this process, the tester may gain experience from different channels. Once the one or more test goals are achieved, the test information (e.g., the IO patterns and combinations of IO patterns utilized) may be recorded to guide future testing tasks. Testers may leverage learned experience, while also trying or exploring new IO patterns and combinations of IO patterns during testing (e.g., with some exploitation-exploration tradeoff).

Such manual approaches have various disadvantages. Performing a deep dive or analysis of source code is time-consuming and not efficient. Further, storage system environments may change continually, and different end-users may utilize storage systems in different ways such that it is complex to model real-world workloads for storage systems. Manual generation of IO patterns and combinations of IO patterns are further heavily dependent upon tester experience, and thus consume huge amounts of manual human resources.

There is thus a need for end-to-end autonomous storage system performance testing solutions which automate the process of generating IO patterns and combinations of IO patterns to be used for testing, evaluating test results, learning from runtime performance of the generated IO patterns and combinations of IO patterns, designing testing improvements, sharing test experiences to help upcoming testing tasks, and updating the learning framework. Illustrative embodiments utilize reinforcement learning to find out what storage IO patterns and combinations of IO patterns have the most effective impact on storage system performance (e.g., CPU or other compute resource utilization, memory utilization, storage bandwidth utilization, IO latency, etc.).

Advantageously, illustrative embodiments enhance storage system performance testing efficiency. Such improvements in efficiency may be in terms of reducing the time or resources needed to hit storage system performance testing goals (e.g., through limiting the number of rounds or other iterations of testing required) utilizing reinforcement learning. This may involve finding the number and diversity of “good” IO patterns and combinations of IO patterns (e.g., where “good” IO patterns and combinations of IO patterns appropriately stress storage system performance to achieve a designated set of storage system performance testing goals), the number of trials for generating an expected performance testing workload, etc. Further, illustrative embodiments provide an end-to-end autonomous storage system performance testing solution, not simply a performance testing automation framework that just follows scheduled steps. Illustrative embodiments also do not require a deep dive or manual analysis of source code or a model of real-world end-user storage workloads, and do not rely on tester experience. Instead, some embodiments keep learning an optimal storage performance tuning policy (e.g., simulating learning in the human brain) with a trial-and-error approach that adaptively reuses the experience of past performance tests for upcoming performance tests (e.g., in accordance with some designated exploitation-exploration tradeoff).

In some embodiments, determining what storage IO patterns and combinations of IO patterns have the most effective impact on storage system performance with a trial-and-error approach is treated as a reinforcement learning problem. Thus, an autonomous storage system performance testing solution may be based on a reinforcement learning framework. Reinforcement learning (RL) is a class of learning problems framed in the context of planning on a Markov Decision Process (MDP), in which agents train a model by interacting with the environment (e.g., a storage system) and where the agents receive rewards from the actions performed correctly (e.g., which meet one or more designated testing goals for testing storage system performance) and penalties from the actions performed incorrectly (e.g., which do not meet or further the one or more designated testing goals for testing storage system performance). After multiple trial-and-error training rounds, the autonomous storage system performance testing solution will know how to reach the target (e.g., the one or more designated testing goals for testing storage system performance) without a person explicitly telling the autonomous storage system performance testing solution how to do so.

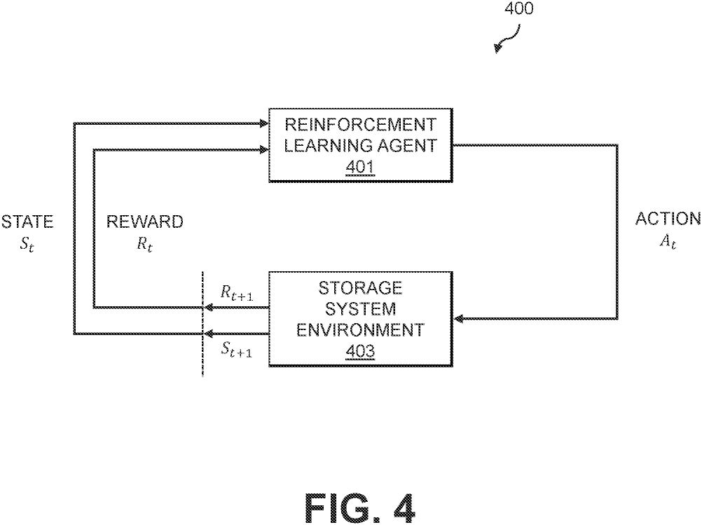

FIG. 4 illustrates a reinforcement learning framework 400, which includes a reinforcement learning agent 401 and a storage system environment 403. As shown, the reinforcement learning agent 401 receives or observes a state Sₜ at a time t. The reinforcement learning agent 401 selects an action Aₜ based on its action selection policy, and transitions to a next state Sₜ₊₁ at a time t + 1. The reinforcement learning agent 401 receives a reward Rₜ₊₁ at a time t + 1. The reinforcement learning agent 401 leverages a reinforcement learning algorithm, which may include but is not limited to a Q-learning algorithm, a Deep Q Networks (DQN) algorithm, a Double DQN (DDQN) algorithm, etc., to update an action-value function Q(Sᵢ,Aᵢ). The action-value function defines a long-term value of taking an action Aᵢ in a state Sᵢ, as will be described in further detail below. Over time, the reinforcement learning agent 401 learns to pursue actions that lead to the greatest cumulative reward at any state.

Techniques for defining states, actions and rewards will now be described. A state space S includes a set of possible state values. A state Sₜ ∈ S is a vector of values from S = {S₁, S₂, ..., Sₙ} at time step t. Sₜ represents test case static information (denoted test_case_info), storage system under test (SUT) static information (denoted SUT_info) and test runtime status information (denoted runtime_infoₜ):

$${S}_{t} = \left\{t e s t \_ c a s e \_ i n f o , S U T \_ i n f o , r u n t i m e \_ i n f {o}_{t}\right\}$$

The test cast static information, test_case_info, represents static test case information, such as a test name. The SUT static information, SUT_info, is a static value representing SUT information such one or more of hardware, platform and drive information of the SUT. The test runtime status information, runtime_infoₜ, represents runtime status (e.g., performance status, capacity usage status, etc.). The runtime status may include, but is not limited to, one or more of a rounding value of average total IOPS, average CPU utilization, average latency, average physical space usage, etc., during execution of a test case. Below is an example of Sₜ:

<test_caseinfo >
Test Name: XXXXXXXXXXX
<SUT_info>
System Hardware :<hardware>
System Platform: <platform>
Drive Information:<Drive>
<runtime_info>
average_total_IOPS=60(K)
average_CPU_Util=70 (percentage)
average_Latency=2ms
average_physical_space_usage=40(percentage)

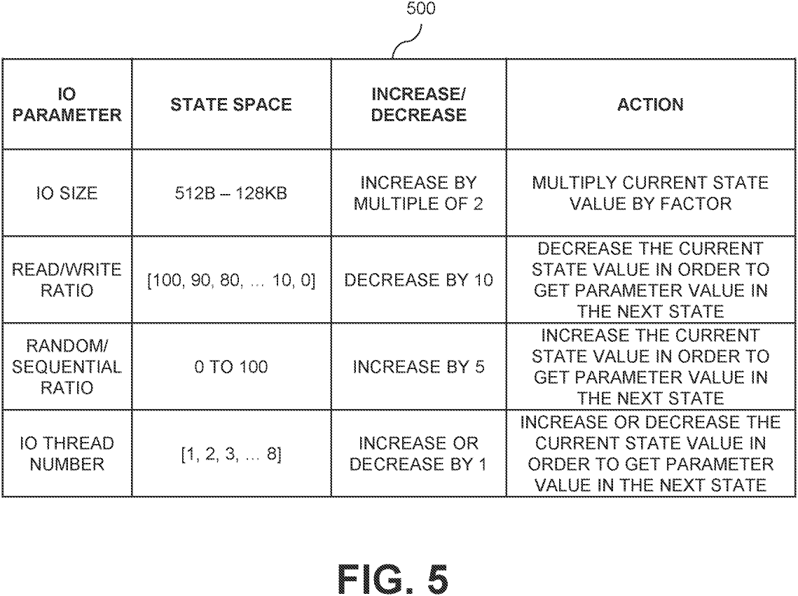

The action space will now be described. The reinforcement learning agent 401, as noted above, observes the current state Sₜ at each time step t and take an action Aₜ. In some embodiments, the action Aₜ involves modifying a single IO pattern value based on some specified storage system performance parameter tuning policy. Consider, for example, the storage system performance parameter tuning policy illustrated in table 500 of FIG. 5. This storage system performance parameter tuning policy includes four critical IO pattern parameters for storage system performance tuning – IO size, read/write ratio, random/sequential ratio, and IO thread number. The table 500 includes, for each such IO parameter, an associated state space, applicable increase/decrease tunings, and actions for tuning that IO parameter value.

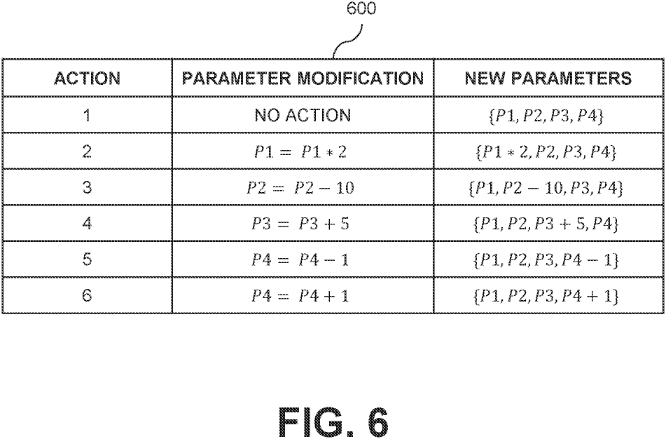

IO tools may have specific configuration parameters supporting different IO patterns. As an example, the vdbench IO tool uses a parameter “xfersize” to specify IO size, a parameter “seekpct/fileio” to specify the random/sequential ratio, a parameter “readpct” to specify the read/write ratio, and a parameter “threads” to specify the IO thread number. Other IO tools, such as FIO, IOmeter, etc. may similarly have parameters enabling configuration of IO size, random/sequential ratio, read/write ratio and IO thread number. For the IO patterns listed in the table 500 of FIG. 5, the IO size parameter is represented as P1, the read/write ratio parameter is represented as P2, the random/sequential ratio parameter is represented as P3, and the IO thread number parameter is represented as P4. The IO pattern parameters are thus {P1, P2, P3, P4}, and the associated action space is shown in the table 600 of FIG. 6.

The reward space will now be described. A reward function R is defined to guide the reinforcement learning agent 401 towards good solutions for a given objective (e.g., one or more designated testing goals for a storage system performance test). The given objective, in some embodiments, is to find IO patterns and combinations of IO patterns which have the most effective impact to storage system performance. The reward Rₜ₊₁ may thus be defined as:

$$\begin{matrix}{R}_{t + 1} = {W}_{1} ∗ {\left(\frac{L a t e n c {y}_{a v e r a g e}}{L a t e n c {y}_{t h r e s h o l d}}\right)}^{2} + {W}_{2} ∗ \\ {\left(\frac{C P {U}_{a v e r a g e}}{C P {U}_{t h r e s h o l d}}\right)}^{2} + {W}_{3} ∗ {\left(\frac{B a n d w i d t {h}_{a v e r a g e}}{B a n d w i d t {h}_{t h r e s h o l d}}\right)}^{2}\end{matrix}$$

where

$${\sum }_{i = 1}^{N} {W}_{i} = 1 ,$$

and Wᵢ denotes the weight ofconfiguration factor i. The particular value of Wᵢ may depend on the testing focus, and can be user-configurable. Rₜ₊₁ is the reward in time step t + 1, Latency_{average} is the average latency for time step t, CPU_{average} is the average CPU or compute resource utilization in time step t, Bandwidth_{average} is the average bandwidth utilization in time step t. Latency_{threshold}, CPU_{threshold}, and Bandwidth_{threshold} are predefined latency, CPU and bandwidth thresholds The higher stress that a particular test case (e.g., an IO pattern or combination of IO patterns) generates, the higher reward the reinforcement learning agent 401 will get. It should be noted that various other key performance indicators (KPIs) may be defined and utilized for defining a reward function, and that embodiments are not limited solely to use with latency, CPU and bandwidth KPIs.

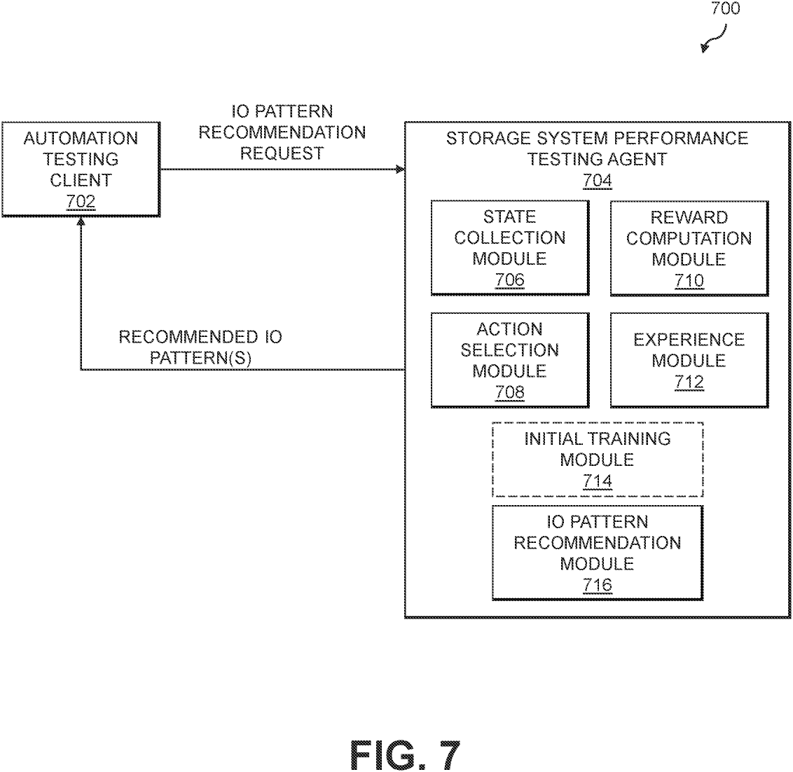

FIG. 7 shows a system 700 for an automation testing client 702 to obtain recommended IO patterns for use in storage system performance testing. The automation testing client 702, in some embodiments, is one of the host devices 102 in the system 100 of FIG. 1 (e.g., where an end-user of one of the host devices 102 initiates automation testing for one or more of the storage arrays 106). In other embodiments, the automation testing client 702 may be one of the storage arrays 106 in the system 100 (e.g., the storage controllers 110 of the storage array 106-1 may initiate automation testing for the storage array 106-1 and/or one or more other ones of the storage arrays 106). The automation testing client 702 issues requests for IO pattern recommendations (e.g., for use in storage system performance testing) to a storage system performance testing agent 704 (e.g., which may be implemented at least in part by the testing parameters recommendation module 112 in some embodiments). The storage system performance testing agent 704 provides for learning-based autonomous performance testing, and may be deployed as a test service which automates the steps of monitoring, learning and decision-making to achieve some specified set of test goals.

The storage system performance testing agent 704 implements a number of functional modules which are utilized in implementing a learning-based autonomous performance testing agent that generates recommended IO patterns which are provided back to the requesting automation testing client 702. Such functional modules include state collection module 706, action selection module 708, reward computation module 710, experience module 712, initial training module 714 and IO pattern recommendation module 716. The state collection module 706 gets the state of a current test case (e.g., being run by the automation testing client 702 which has requested IO pattern recommendations). The state of the current test case may include, but is not limited to, static and runtime information such as system platform, IO latency, IOPS, bandwidth, CPU or other compute resource utilization, memory utilization, etc.

The action selection module 708 observes the current state (e.g., Sₜ) and provides an IO pattern tuning action Aₜ to the storage system environment. The reward computation module 710 calculates the reward Rₜ of action Aₜ in state Sₜ based on a set of specified storage system performance testing goals (e.g., finding IO patterns and combinations of IO patterns which stress a storage system with fewer trials to provide for more efficient testing). The experience module 712 uses a reinforcement learning algorithm to update the experience according to the current state, action, reward and next state. The experience Q(Sᵢ,Aᵢ) is a mapping between the storage system environment states and actions that maximize a long-term reward.

The initial training module 714 gathers some initial experience to build an initial experience model which can be leveraged directly for upcoming new testing tasks. With the initial training module 714, the storage system performance testing agent 704 can find the “good” IO patterns and combinations of IO patterns with fewer trials, since upcoming tasks can leverage existing learned experience. It should be noted that use of the initial training module 714 is optional, and may be deployed as an advanced service in some embodiments.

The IO pattern recommendation module 716 recommends IO patterns and IO pattern combinations which have the most effective impact on system performance based on the learned experience (e.g., from experience module 712).

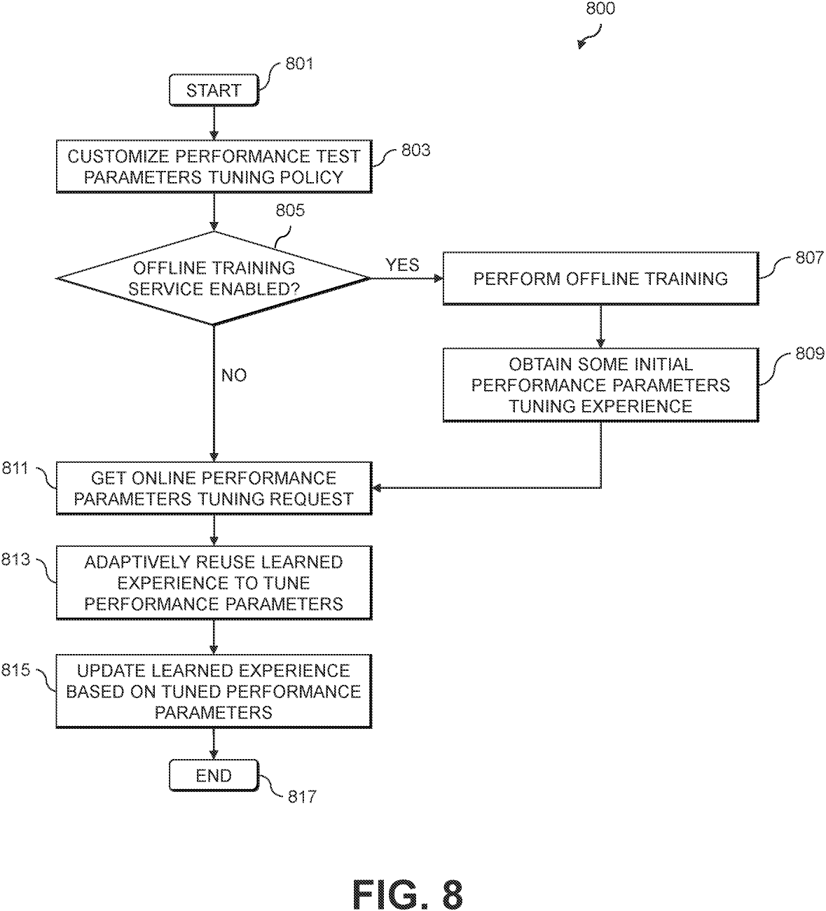

FIG. 8 shows a process flow 800 for the storage system performance testing agent 704 to generate IO pattern recommendations. The process flow 800 starts 801, and a tester customizes storage system performance testing parameters and a testing parameter tuning policy before running storage system performance tests in step 803. For example, the tester may identify the IO parameters that are to be used for tuning, as well as a tuning state space, a tuning interval, IO tools, the state which ends tuning, and whether offline training is enabled (e.g., whether functionality of the initial training module 714 is enabled).

In step 805, a determination is made as to whether the offline training service is enabled (e.g., whether the functionality of the initial training module 714 is enabled). If the result of the step 805 determination is yes, the process flow 800 proceeds to step 807. In step 807, the initial training module 714 starts offline training to obtain some initial experience, which is then used to guide online training to hit testing goals quicker (e.g., with fewer testing trials or iterations). The training, in some embodiments, is performed in an episodic framework where in every episode, the storage system performance testing agent 704 starts from a random state and performs a fixed number of training steps. Such training steps are:

T.1. A random IO parameter combination is generated as time step t. For example, if the four IO parameters of table 500 of FIG. 5 are used, the IO parameter combination at time t is parameterₜ = {P1, P2, P3, P4}.

T.2. The action space is identified based on a tuning policy (e.g., defined in step 803) and parameterₜ. Table 600 of FIG. 6 shows an example action space.

T.3. A performance test case with the IO parameter combination parameterₜ is executed on the SUT. During execution, the state collection module 706 monitors status of the storage system and calculates Sₜ = {test_case_info, SUT_info, runtime_infoₜ}.

T.4. The action selection module 708 follows a tuning policy to select an action from the action space. In some embodiments, the tuning policy is an ε-greedy policy, whereby the action selection module 708 selects with probabiltiy ε a random action from the action space and otherwise takes the best action (e.g., an action having the highest Q(Sᵢ Aᵢ) from the action space). A new set of IO parameters, parametersₜ₊₁, is then generated. Here, the action may be to modify a single IO parameter of parametersₜ, where the single action may be one of those specified in table 600 of FIG. 6.

T.5. The performance test case is then executed with the new IO parameters, parametersₜ₊₁, to get a reward Rₜ₊₁ from the reward computation module 710 and the next state Sₜ₊₁ = {test_case_info, SUT_info, runtime_infoₜ₊₁} from state collection module 706.

T.6. The next state, Sₜ₊₁, is then set as the current state and steps 2-5 are repeated for a fixed number of training steps or until a predefined terminal state is reached. The terminal state, which may be specified in step 803, may be to stop training when the SUT’s runtime average latency, CPU or other compute resource utilization, and bandwidth utilization exceed some predefined threshold values.

T.7. The experience module 712 uses a reinforcement learning algorithm and records of (Sₜ, Aₜ, Rₜ₊₁, Sₜ₊₁) to update Q(Sᵢ, Aᵢ) in order to approximate an optimal tuning policy. Various different reinforcement learning algorithms may be used, including but not limited to Q-learning, DQN and DDQN algorithms.

T.8. At the end of each episode, ε is gradually decreased.

The storage system performance testing agent 704 obtains initial performance parameter tuning experience in step 809 (e.g., through one or more episodes of steps T.1-T.8 above), where the experience may include information relating to the state and recommended IO patterns and combinations of IO patterns which hit one or more designated testing goals, and an action-value mapping Q(Sᵢ Aᵢ) which represents the long-term value of action Aᵢ at any state Sᵢ. Here, “long-term” value refers to the possibility of hitting one or more designated testing goals in the future after taking the action Aᵢ (e.g., if the one or more designated testing goals are not met immediately after taking the action Aᵢ).

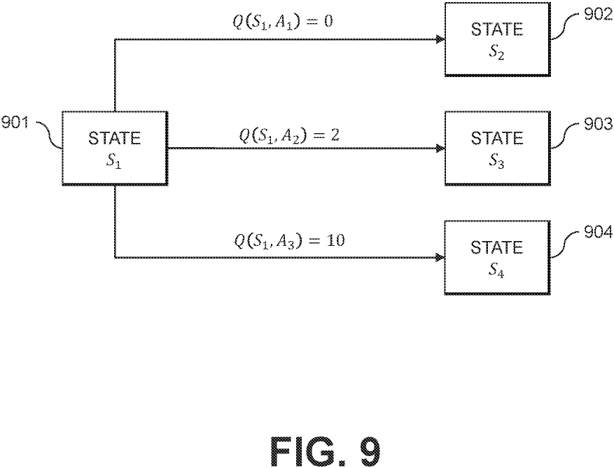

Long-term value is illustrated in FIG. 9, which shows various examples of actions that may be taken from a state S₁ 901. At state S₁ 901, after taking a first action A₁ a state S₂ 902 is reached. From state S₂ 902, there is no possibility of hitting the one or more designated testing goals (from the experience learned thus far). Thus, Q(S₁,A₁) = 0, which means the first action A₁ does not have long-term value. At state S₁ 901, after taking a second action A₂ a state S₃ 903 is reached. In state S₃ 903 the one or more designated testing goals are not achieved, but upcoming actions starting from the state S₃ 903 do eventually lead to achieving the one or more designated testing goals. Thus, the second action A₂ has value for the long term instead of the short term, and Q(S₁,A₂) = 2. At state S₁ 901, after taking a third action A₃ the state S₄ 904 is reached where the one or more designated testing goals are achieved immediately, and thus Q(S₁,A₃) = 10. The experience Q(Sᵢ Aᵢ) will get more and more accurate with every training iteration or episode. If enough training is performed, it will converge and represent the true Q-value.

In step 811, the storage system performance testing agent 704 receives an online performance test parameter tuning request from the automation testing client 702. Step 811 may be performed following steps 807 and 809, or following step 803 if the result of the step 805 determination is no. For example, a performance test case which failed to achieve the one or more designated testing goals may trigger step 811 automatically. The performance test parameter tuning request, also referred to as a request for IO pattern recommendations, is assumed to include Sₜ = {test case_info, SUT_info, runtime_infoₜ}.

In step 813, the storage system performance testing agent 704 adaptively reuses learned knowledge or experience to help test cases achieve the one or more designated testing goals. In some embodiments, there are three different modes for adaptively reusing the experience. In an exploitation mode, if the state Sₜ is in a state list which hits or meets the one or more designated testing goals, the storage system performance testing agent 704 will recommend the IO parameter combination of this state to the test case directly. In other words, the storage system performance testing agent 704 will re-use its experience completely to try to achieve the one or more designated testing goals quickly. In an exploration and exploitation tradeoff mode, if the state Sₜ is found in the experience (e.g., maintained by the experience module 712) as a known state, the storage system performance testing agent 704 will follow the ε-greedy policy to modify the existing IO parameters (steps T.3-T.7). As discussed above, the ε-greedy policy with probability ε selects a random action from the action space, and otherwise takes the best action (e.g., with the highest Q(S_{i,}Aᵢ) value) from the action space. Here, ε is a value less than 1, which means the storage system performance testing agent 704 will try to re-use learned experience and at the same time try to explore some new IO parameters to update and expand the learned experience. In an exploration mode, if the state Sₜ is not found in the experience as a known state, it is added to the experience and the ε-greedy policy is followed to modify the IO parameters. In the exploration mode, ε is set to 1 which means the storage system performance testing agent 704 will try to explore the action space when in a completely “new” state (e.g., a state for which there is no learned experience).

In step 815, the experience module 712 keeps using the reinforcement learning algorithm to record additional (S_{t,} Aₜ, Rt₊₁, Sₜ₊₁) records and to update Q(S_{i,} Aᵢ). In this way, the learned experience keeps updating over time. Thus, over time better recommendations for IO patterns and combinations of IO patterns are provided which improve storage system performance testing efficiency. The process flow 800 then ends 817.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for generating parameter values for performance testing utilizing a reinforcement learning framework will now be described in greater detail with reference to FIGS. 10 and 11. Although described in the context of system 100, these platforms may also be used to implement at least portions of other information processing systems in other embodiments.

FIG. 10 shows an example processing platform comprising cloud infrastructure 1000. The cloud infrastructure 1000 comprises a combination of physical and virtual processing resources that may be utilized to implement at least a portion of the information processing system 100 in FIG. 1. The cloud infrastructure 1000 comprises multiple virtual machines (VMs) and/or container sets 1002-1, 1002-2, ... 1002-L implemented using virtualization infrastructure 1004. The virtualization infrastructure 1004 runs on physical infrastructure 1005, and illustratively comprises one or more hypervisors and/or operating system level virtualization infrastructure. The operating system level virtualization infrastructure illustratively comprises kernel control groups of a Linux operating system or other type of operating system.

The cloud infrastructure 1000 further comprises sets of applications 1010-1, 1010-2, ... 1010-L running on respective ones of the VMs/container sets 1002-1, 1002-2, ... 1002-L under the control of the virtualization infrastructure 1004. The VMs/container sets 1002 may comprise respective VMs, respective sets of one or more containers, or respective sets of one or more containers running in VMs.

In some implementations of the FIG. 10 embodiment, the VMs/container sets 1002 comprise respective VMs implemented using virtualization infrastructure 1004 that comprises at least one hypervisor. A hypervisor platform may be used to implement a hypervisor within the virtualization infrastructure 1004, where the hypervisor platform has an associated virtual infrastructure management system. The underlying physical machines may comprise one or more distributed processing platforms that include one or more storage systems.

In other implementations of the FIG. 10 embodiment, the VMs/container sets 1002 comprise respective containers implemented using virtualization infrastructure 1004 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1000 shown in FIG. 10 may represent at least a portion of one processing platform. Another example of such a processing platform is processing platform 1100 shown in FIG. 11.

The processing platform 1100 in this embodiment comprises a portion of system 100 and includes a plurality of processing devices, denoted 1102-1, 1102-2, 1102-3, ... 1102-K, which communicate with one another over a network 1104.

The network 1104 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1102-1 in the processing platform 1100 comprises a processor 1110 coupled to a memory 1112.

The processor 1110 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1112 may comprise random access memory (RAM), read-only memory (ROM), flash memory or other types of memory, in any combination. The memory 1112 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1102-1 is network interface circuitry 1114, which is used to interface the processing device with the network 1104 and other system components, and may comprise conventional transceivers.

The other processing devices 1102 of the processing platform 1100 are assumed to be configured in a manner similar to that shown for processing device 1102-1 in the figure.

Again, the particular processing platform 1100 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for generating parameter values for performance testing utilizing a reinforcement learning framework as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, storage systems, IO parameters and associated tuning policies, reinforcement learning frameworks, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured to perform steps of:
detecting a request for parameter values for a set of parameters to be utilized in a given iteration of performance testing of an information technology asset in an information technology infrastructure;
determining a current state of the information technology asset, the current state of the information technology asset comprising two or more performance metric values for the information technology asset;
generating, utilizing a reinforcement learning framework, the parameter values for the set of parameters to be utilized in the given iteration of the performance testing of the information technology asset based at least in part on the current state of the information technology asset;
performing the given iteration of performance testing of the information technology asset utilizing the generated parameter values for the set of parameters; and
updating the reinforcement learning framework based at least in part on a subsequent state of the information technology asset following the given iteration of performance testing of the information technology asset.

2. The apparatus of claim 1 wherein the current state of the information technology asset further comprises testing information associated with the performance testing of the information technology asset and configuration information for the information technology asset.

3. The apparatus of claim 2 wherein the configuration information for the information technology asset comprises at least one of a hardware configuration of the information technology asset and a software configuration of the information technology asset.

4. The apparatus of claim 1 wherein generating the parameter values for the set of parameters to be utilized in the given iteration of the performance testing of the information technology asset is further based at least in part on learned experience of the reinforcement learning framework, the learned experience comprising characterizations of whether different sets of one or more actions that modify the parameter values for the set of parameters, taken from the current state of the information technology asset, meet one or more designated testing goals for the performance testing of the information technology asset.

5. The apparatus of claim 4 wherein the reinforcement learning framework utilizes a reward function which assigns a reward to the generated parameter values for the set of parameters utilized in the given iteration of performing testing of the information technology asset based at least in part on whether the subsequent state of the information technology asset following the given iteration of performance testing of the information technology asset advances the one or more designated testing goals.

6. The apparatus of claim 4 wherein the one or more designated testing goals comprise target utilization values for the two or more performance metrics of the information technology asset.

7. The apparatus of claim 4 wherein the request for the parameter values for the set of parameters to be utilized in the given iteration of the performance testing of the information technology asset is detected responsive to determining that a previous iteration of the performance testing of the information technology asset did not meet the one or more designated testing goals.

8. The apparatus of claim 1 wherein generating the parameter values for the set of parameters to be utilized in the given iteration of the performance testing of the information technology asset comprises determining whether the current state of the information technology asset matches any of a plurality of state-action records of learned experience maintained by the reinforcement learning framework, each of the plurality of state-action records specifying a given value characterizing an extent to which taking a given set of one or more actions for modifying the parameter values for the set of parameter values from a given state of the information technology asset meets one or more designated testing goals for the performance testing of the information technology asset.

9. The apparatus of claim 8 wherein, responsive to determining that the current state of the information technology asset does not match any of the plurality of state-action records, selecting a set of one or more actions for modifying the parameter values for the set of parameters randomly from an action space, the action space defining permissible modifications to respective ones of the parameters in the set of parameters.

10. The apparatus of claim 8 wherein, responsive to determining that the current state of the information technology asset matches a given one of the plurality of state-action records:
selecting, with a first probability, a first set of one or more actions specified in the given one of the plurality of state-action records matching the current state of the information technology asset; and
selecting, with a second probability, a second set of one or more actions for modifying the parameter values for the set of parameters randomly from an action space, the action space defining permissible modifications to respective ones of the parameters in the set of parameters.

11. The apparatus of claim 8 further comprising, responsive to determining that the given value specified in the given one of the plurality of state-action records matching the current state of the information technology asset indicates that the given set of one or more actions for modifying the parameter values for the set of parameters will meet the one or more designated testing goals within a threshold number of iterations of performance testing of the information technology asset, setting the second probability to zero.

12. The apparatus of claim 8 further comprising, responsive to determining that the given value specified in the given one of the plurality of state-action records matching the current state of the information technology asset indicates that the given set of one or more actions for modifying the parameter values for the set of parameters will not meet the one or more designated testing goals within a threshold number of iterations of performance testing of the information technology asset, setting the second probability to a non-zero value.

13. The apparatus of claim 1 wherein the information technology asset comprises a storage system, and the set of parameters comprise two or more input-output parameters to be utilized in modeling application workloads executing on the storage system.

14. The apparatus of claim 13 wherein the two or more input-output parameters comprise at least two of input-output size, a read/write ratio, a random/sequential ratio, and an input-output thread number.

15. A computer program product comprising a non-transitory processor-readable storage medium having stored therein program code of one or more software programs, wherein the program code when executed by at least one processing device causes the at least one processing device to perform steps of:
detecting a request for parameter values for a set of parameters to be utilized in a given iteration of performance testing of an information technology asset in an information technology infrastructure;
determining a current state of the information technology asset, the current state of the information technology asset comprising two or more performance metric values for the information technology asset;
generating, utilizing a reinforcement learning framework, the parameter values for the set of parameters to be utilized in the given iteration of the performance testing of the information technology asset based at least in part on the current state of the information technology asset;
performing the given iteration of performance testing of the information technology asset utilizing the generated parameter values for the set of parameters; and
updating the reinforcement learning framework based at least in part on a subsequent state of the information technology asset following the given iteration of performance testing of the information technology asset.

16. The computer program product of claim 15 wherein generating the parameter values for the set of parameters to be utilized in the given iteration of the performance testing of the information technology asset is further based at least in part on learned experience of the reinforcement learning framework, the learned experience comprising characterizations of whether different sets of one or more actions that modify the parameter values for the set of parameters, taken from the current state of the information technology asset, meet one or more designated testing goals for the performance testing of the information technology asset.

17. The computer program product of claim 15 wherein the information technology asset comprises a storage system, and the set of parameters comprise two or more input-output parameters to be utilized in modeling application workloads executing on the storage system.

18. A method comprising:
detecting a request for parameter values for a set of parameters to be utilized in a given iteration of performance testing of an information technology asset in an information technology infrastructure;
determining a current state of the information technology asset, the current state of the information technology asset comprising two or more performance metric values for the information technology asset;
generating, utilizing a reinforcement learning framework, the parameter values for the set of parameters to be utilized in the given iteration of the performance testing of the information technology asset based at least in part on the current state of the information technology asset;
performing the given iteration of performance testing of the information technology asset utilizing the generated parameter values for the set of parameters; and
updating the reinforcement learning framework based at least in part on a subsequent state of the information technology asset following the given iteration of performance testing of the information technology asset;
wherein the method is performed by at least one processing device comprising a processor coupled to a memory.

19. The method of claim 18 wherein generating the parameter values for the set of parameters to be utilized in the given iteration of the performance testing of the information technology asset is further based at least in part on learned experience of the reinforcement learning framework, the learned experience comprising characterizations of whether different sets of one or more actions that modify the parameter values for the set of parameters, taken from the current state of the information technology asset, meet one or more designated testing goals for the performance testing of the information technology asset.

20. The method of claim 18 wherein the information technology asset comprises a storage system, and the set of parameters comprise two or more input-output parameters to be utilized in modeling application workloads executing on the storage system.
